(19) United States
(12) Patent Application Publication
(10) Pub. No.: US 2010/0023397 A1
(43) Pub. Date: Jan. 28, 2010

(54) Video Promotion In A Video Sharing Site

(76) Inventors: Jonathan Goldman, San Francisco, CA (US); Aaron Lee, Mountain View, CA (US); Matthew Liu, Fremont, CA (US); Thai Tran, Redwood City, CA (US)

Correspondence Address: GOOGLE / FENWICK, SILICON VALLEY CENTER, 801 CALIFORNIA ST., MOUNTAIN VIEW, CA, 94041, US

(21) Appl. No.: 12/508,460

(22) Filed: Jul. 23, 2009

Related U.S. Application Data
(60) Provisional application No. 61/083,156, filed on Jul. 23, 2008.
(60) Provisional application No. 61/114,055, filed on Nov. 12, 2008.

(51) Int. Cl. G06Q 30/00; G06F 17/30; G06F 7/10

(52) U.S. Cl. 705/14.48; 707/3; 705/14.55; 705/14.53; 705/14.54; 707/E17.009; 707/E17.108; 707/104.1

(57) ABSTRACT

A promoter wishing to promote video content on a video hosting website selects the video and associates it with an advertising creative. The promoter selects associated keywords and indicates financial terms for the promotion, for example by agreeing to a cost-per-click or cost-per-impression payment arrangement with the video hosting site. When a user of the video hosting site performs a search on the keywords (or similar words) associated with the promoted video, the video hosting website includes the creative for the promoted video with the other search results returned. The user can then select to view any of the search results or the promoted video identified by the creative. When the user clicks on the indicia for the promoted video, the video hosting site serves to the user a watch page on which the user views the promoted video. The promoter is charged according to the payment mechanism selected.

### CROSS-REFERENCE TO RELATED APPLICATIONS

This application claims the benefit of U.S. Provisional application 61/083,156, filed on Jul. 23, 2008; and claims the benefit of U.S. Provisional application 61/114,055, filed on Nov. 12, 2008; both of which are incorporated by reference herein in their entirety.

### BACKGROUND

1. Field

The present invention relates generally to providing advertising on a web site. In particular, the present invention is directed to promoting videos available on a video hosting website.

2. Description of the Related Art

An increasing amount of video available online is being discovered through searching. Searching is a prominent function of video hosting web sites such as Google Video and YouTube, and accounts for hundreds of millions of daily page views on those sites and others.

Conventional search advertisements are not designed to be used in video search. Users who perform searches on these video sites often have a different mindset than those who perform web searches. Web searchers are often looking for information (e.g., “how can I train my dog?)” and are not looking for a specific web site or source of information. In contrast, video searchers are typically trying to locate either a specific video or a selection of videos that will entertain them, and not seeking information; most video searches are not queries for information.

Content providers also struggle to find ways to promote their content. If more people watch their content, content providers can make more money. In some cases, they can turn to large video portals and hope to be spotted by a community of fans, but in other cases it is very difficult and these content providers frequently occupy niches where they are difficult for users to find.

### SUMMARY

The present invention enables promotion of specific video content available on a video hosting website. An entity—known as a promoter—wishing to promote a video selects the video and associates it with an advertising creative. The promoter selects a set of keywords with which the promoted video and its creative should be associated. The promoter also indicates financial terms for the promotion, for example by agreeing to a cost-per-click (CPC) or cost-per-impression (CPM) payment arrangement with the video hosting site. That is, the promoter pays the video site on, for example, a CPC or CPM basis for viewers watching or clicking on the advertising creative. In one embodiment, the promoter recoups some of the promotion cost by allowing others to place advertisements on a watch page displaying the promoted video.

When a user of the video hosting site performs a search on the keywords (or similar words) associated with the promoted video, the video hosting website includes the advertising creative for the promoted video along with the other search results returned for the query. The user can then select to view any of the search results or the promoted video identified by the advertising creative. The promoter is charged according to the payment mechanism selected.

### BRIEF DESCRIPTION OF THE DRAWINGS

FIG. 1 illustrates an environment and system architecture of a video hosting service in accordance with an embodiment of the present invention.

FIG. 2 illustrates a method for providing promoted videos in a video hosting website in accordance with an embodiment of the present invention.

FIG. 3 illustrates a web interface for selecting videos to be promoted in accordance with an embodiment of the present invention.

FIGS. 4A and 4B illustrate web interfaces for specifying parameters for video promotion in accordance with an embodiment of the present invention.

FIG. 5 illustrates a web interface providing search results including promoted video results in accordance with an embodiment of the present invention.

FIG. 6 illustrates a web interface including a watch page in which a promoted video is displayed to a viewer in accordance with an embodiment of the present invention.

FIG. 7 illustrates a system for providing promoted videos to a third-party site in accordance with an embodiment of the present invention.

FIGS. 8A and 8B illustrate the presentation of promoted videos in an embedded video player in accordance with an embodiment of the present invention.

The figures depict preferred embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

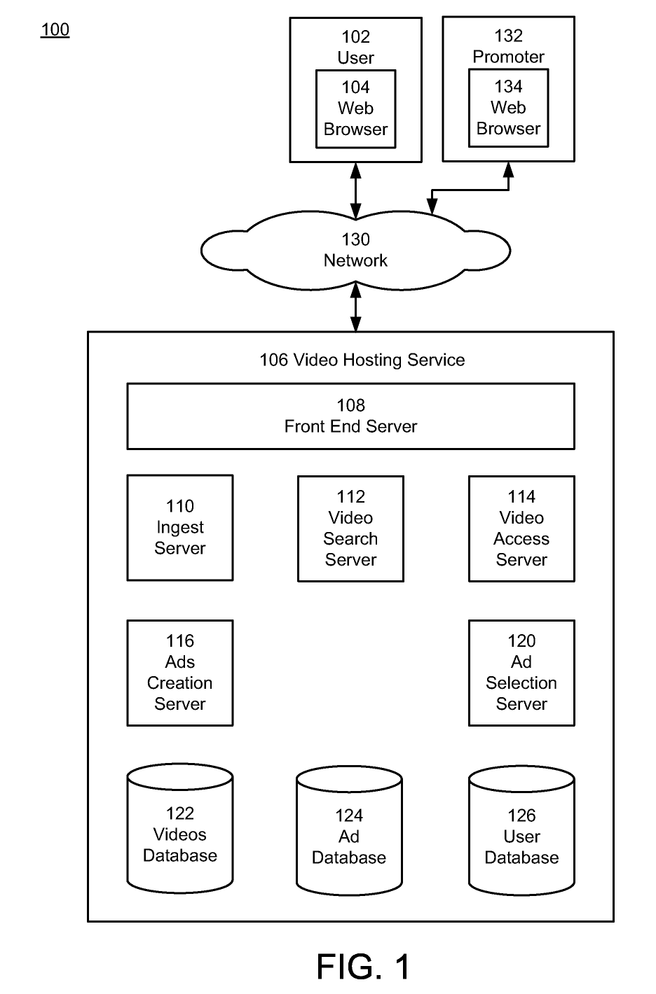

FIG. 1 is a block diagram of the environment 100 and system architecture of a video hosting service 106 according to one embodiment. FIG. 1 illustrates a video hosting service 106 connected by a network 130 to a user 102 and promoter 132. The user represents an entity that can access videos included in the video hosting service 106. A user can access a video from the video hosting service 106 directly (e.g., by entering a URL), by browsing a catalog of videos, conducting searches using keywords, reviewing play lists from other users or the system administrator (e.g., collections of videos forming channels), or viewing videos associated with particular user groups (e.g., communities). Additionally, in some embodiments, the video hosting service 106 is adapted to receive videos for storage in order to enable the sharing of the videos with other users. Promoter 132 represents an entity that provides a video to be advertised along with other search results on video hosting service 106.

In one embodiment, the user uses a computer system to communicate with the video hosting service 106 over the network 130. In one embodiment, the video hosting service 106 is implemented at least in part using web-based technologies to support a website, in which case the user's computer system is a personal computer executing a web browser 104 such as MICROSOFT INTERNET EXPLORER, MOZILLA FIREFOX, or GOOGLE CHROME that allows the user to view web pages and videos provided by the video hosting service 106. In one embodiment, the web browser 104 includes a video player (e.g., a player implemented using Flash™ from Adobe Systems, Inc.). The user may utilize a network-capable device other than a computer system, such as a personal digital assistant (PDA), a cellular telephone, a pager, a television set-top box, etc. Although FIG. 1 illustrates only a single user and a single promoter, many users and promoters can communicate with the video hosting service 106 at any time. A single instance of each is illustrated in order to clarify the present description.

The network 130 represents the communication pathways between the user and the video hosting service 106. In one embodiment, the network 130 is the Internet, but may also be any network, including but not limited to a LAN, a MAN, a WAN, a mobile, wired or wireless network, a private network, or a virtual private network, and any combination thereof. In addition, all or some of links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

Most generally, the video hosting service 106 represents any system that allows users to access video content via searching and/or browsing interfaces. The sources of videos can be from uploads of videos by users, searches or crawls of other websites or databases of videos, or the like, or any combination thereof. For example, in one embodiment, a video hosting service 106 can be configured to allow upload of content by users. In another embodiment, a video hosting service 106 can be configured to only obtain videos from other sources by crawling such sources or searching such sources in real time.

For clarity of description, we refer to the content received and shared by the video hosting service 106 as videos, or video items, but the video hosting service 106 can receive and share content of any media type and file type. A suitable video hosting service 106 for implementation of the system is the YOUTUBE™ website; other video hosting services are known as well, and can be adapted to operate according to the teaching disclosed herein. It will be understood that the term “website” represents any computer system adapted to serve content using any internetworking protocols, and is not intended to be limited to content uploaded or downloaded via the Internet or the HTTP protocol. In general, functions described in one embodiment as being performed on the server side can also be performed on the client side in other embodiments if appropriate. In addition, the functionality attributed to a particular component can be performed by different or multiple components operating together.

The video hosting service 106 includes a front end server 108, an ingest server 110, a video search server 112, a video access server 114, an advertisement creatives creation server (or simply “ads creations server”) 116, an ad selection server 120, a videos database 122, an ad database 124, and a user database 126. Many conventional features, such as firewalls, load balancers, application servers, failover servers, site management tools and so forth are not shown so as not to obscure the features of the system.

Each of the various servers is implemented as a server program executing on a server-class computer comprising a CPU, memory, network interface, peripheral interfaces, and other well known components. The computers themselves preferably run an open-source operating system such as LINUX, have generally high performance CPUs, 1G or more of memory, and 100G or more of disk storage. Of course, other types of computers and operating systems can be used, and it is expected that as more powerful computers are developed in the future, they can be configured in accordance with the teachings here. The functionality implemented by any of the elements can be provided from computer program products that are stored in tangible computer accessible storage mediums (e.g., RAM, hard disk, or optical/magnetic media).

The front end server 108 handles communication with the user 102 and promoter 132 via the network 130. The front end server 108 receives requests from users and communicates with the other servers of the video hosing service 106 to process the requests. For example, if a user requests to access a video, the front end server 108 makes sure that the proper servers process the request and that the video is transmitted to the user. Similarly, promoters 132 communicate via front end server 108 to create and configure promoted videos in conjunction with other components of video hosting service 106 as described further below.

The ingest server 110 processes videos received by the front end server 108 from a user for posting to the video hosting service 106. In one embodiment, the processing of a video received includes assigning a video identification (video ID) to the video and storing the video in a videos database 122. In one embodiment, the videos database 122 is a storage system that includes videos shared by the video hosting service 106 with users. Other steps that may be involved in the processing of the received video before storing it in the videos database 122 include: formatting (e.g., transcoding), compressing, metadata tagging, content analysis, and/or other data processing methods.

In one embodiment, the front end server 108 receives a form with the video received from the user. The form includes information entered by the user about the video, such as the title, description, and tag information. The form may additionally include information describing which users have administrative rights to the video. In one embodiment, administrative rights allow a user to delete a video, edit information about the video, and associate the video with an ad. In one embodiment, a user may be given different levels of administrative rights. For example, a user may be given rights to associate a video with ads, but may not be given rights to delete the video from the videos database 122. The ingest server 110 stores the information included in the form as metadata of the video in the videos database 122. In some embodiments, some or all of the metadata can be derived automatically instead of, or in addition to, being supplied by the user.

Additionally, the ingest server 110 updates data contained in user database 126 about the user that transmitted the video to the video hosting service 106. In one embodiment, the ingest server 110 stores the video ID assigned to the stored video with the data of the respective user in the user database 126. The user database 126 includes data on users that communicate with the video hosting service 106. An example of data included in the user database 126 for a specific user includes the video IDs of videos transmitted by the user to the video hosting service 106 and the video IDs of videos that the user has accessed from the videos database 122 for viewing. In one embodiment, users are identified using a login name and password and/or by using the user's internet protocol address.

The video search server 112 processes any search queries received by the front end server 108 from users. A search query received by the front end server 108 from a user includes search criteria, such as keywords that may identify videos the user is interested in viewing. The video search server 112 uses the search criteria to query the metadata of videos stored in the videos database 122. The search results from the query are transmitted to the front end server 108 for presentation to the user. For example, if a user provides the front end server 108 with a keyword search query with the word “puppies” the video search server 112 identifies videos stored in the videos database 122 related to the word “puppies.”

The ad selection server 120 works in conjunction with video search server 112 to select a promoted video to display in conjunction with the search results. Ad selection server 120 selects a promoted video based on keywords associated with the search query, and in some embodiments based also on demographics of the searcher, time of day, and other criteria, and displays an advertising creative from ad database 124 associated with the promoted video along with the search results.

The video access server 114 processes requests from users, also referred to here as viewers, to access certain videos. In one embodiment, the video access server 114 receives a request from a viewer to access a video when the viewer clicks on a link to the video. The request received from the viewer includes the video ID of the video the viewer wishes to access for viewing (this can be included automatically once the viewer clicks on the link for the video). The video access server 114 uses the video ID to search and locate the video in the videos database 122. Once the requested video is located, the video access server 114 transmits the video to the viewer via front end server 108. The video is presented to the viewer, for example in the user's web browser 104. Metadata associated with the video may also be presented with the video, such as the title and description of the video.

The ads creation server 116 allows promoters 132 to configure the parameters for their video promotion, including selecting or uploading an advertising creative, specifying which keywords should trigger display of the promoted video in search results, demographic and other filters to limit display, pricing information (such as a cost-per-click bid), etc.

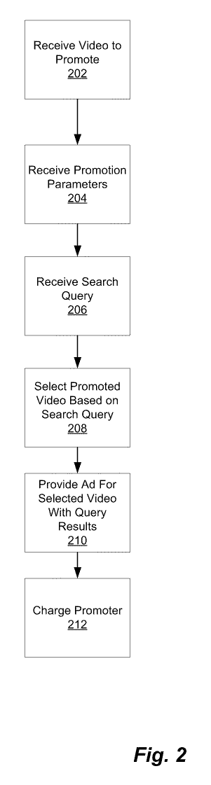

FIG. 2 illustrates a method for providing promoted videos on a video hosting website in accordance with an embodiment of the present invention. To begin, video hosting website 106 receives 202 a video to be promoted from promoter 132. The video may be provided to the site 106 on physical media, or via network 130, in a manner similar or identical to the manner in which other videos are provided, and may be identified at time of upload or at a later time as a video to be promoted. The received video is handled by ingest server 110 as described above and is stored in videos database 122. Next, ad creation server 116 receives 204 promotion parameters from promoter 132. Parameters include one or more keywords of a search query that should be associated with the promoted video, as well as indicia such as a description and title and thumbnail (or video) image that should appear for the promoted video when presented with other search results. The promoter 132 also specifies a type of advertising payment scheme to apply to the promotion, including for example, cost-per-click (CPC) or cost-per-impression (CPM). Pricing may be set by video hosting site 106 as a fixed price, or may depend upon keywords and other parameters, and may also depend on a specified budget provided by promoter 132.

Note that although in FIG. 2, the video to be promoted is received first, in alternative embodiments, the video may be uploaded at a different stage of the flow—for example, after the parameters have been specified.

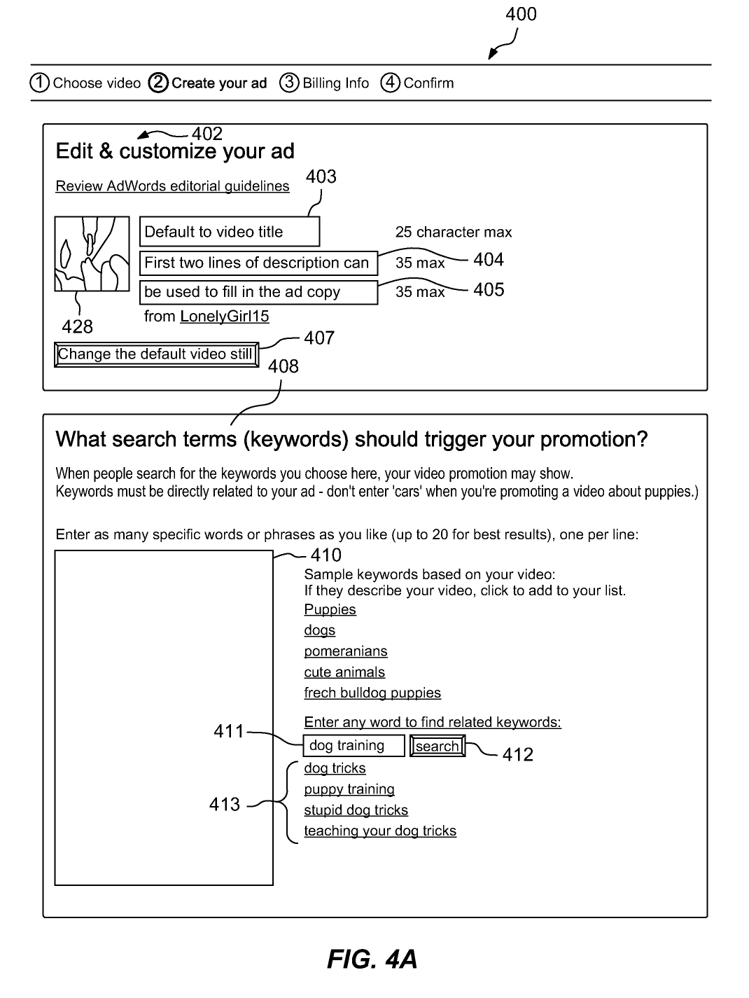

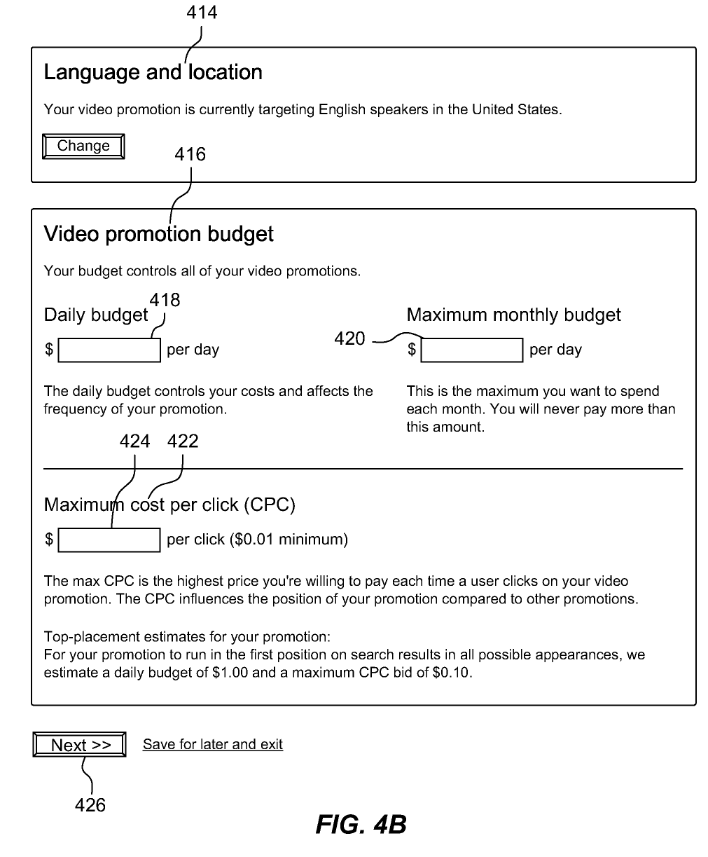

A request is then received 206 by video search server 112 of video hosting server 106 from a user 102. Video search server 112 executes a conventional search for video results based on the search query and videos stored in videos database 122. In addition, ad selection server 120 selects 208 a promoted video from videos database 122 to be promoted in the provided search results. Ad selection server 120 makes the selection based on a match between the keywords associated with the search query and the keywords specified by promoter 132, as well as factors including the bid price, popularity of the search terms, and the like. In various embodiments, the number of promoted videos that are a suitable match exceeds the number of advertising slots available on the search results page. Ad selection server 120 thus chooses from among the qualifying matches according to criteria established by the implementer, for example by using well-known optimization algorithms that maximize revenue to the site, ensure compliance with advertiser contracts, and the like. Video search server 112 then presents 210 the search results to the user, and includes among the search results the advertising creative associated with the promoted video. As described below with respect to FIG. 4A, in one embodiment the advertising creative (or simply “creative”, or “ad”) is provided as a promotion parameter, and includes a headline, text, and thumbnail from the video being promoted that, when selected by a viewer, links to the video being promoted by the creative. In alternative embodiments, the creative may be formatted differently, have more or less text, have more or no thumbnails, etc. In one embodiment, video search server 112 normalizes some or all of the provided search keywords according to a stored mapping in order to provide improved search results. For example, a search for “puppies” may be mapped on to keyword “dog” in order to increase the availability of search results.

If the user 102 selects one of the search results other than the promoted video, the video is then played in a conventional manner, e.g., by displaying the video's watch page to the user, playing the video inline from the results list, etc. Alternatively, if the user 102 selects the advertisement for the promoted video, then an action specified in the promotion parameters is taken, which may include displaying the promoted video's watch page, loading a channel page associated with the parameter, playing the video in-line, etc. In one embodiment, the video promotion advertisement is labeled in the search results listing as a promoted video or advertisement; in alternative embodiments it is presented in a manner identical to other search results.

The promoter 132 is then charged 212 for the cost of the instance of the video promotion. The cost may vary according to the terms of the advertising arrangement and advertising model agreed upon.

In one embodiment, video hosting site 106 provides user channels. A channel is a web page associated with a particular user of hosting site 106, and typically includes a user's profile information, videos, favorites, etc. A user's channel can be a searchable element (i.e. returned as a search result), and in one embodiment can also be promoted in the same manner as a video.

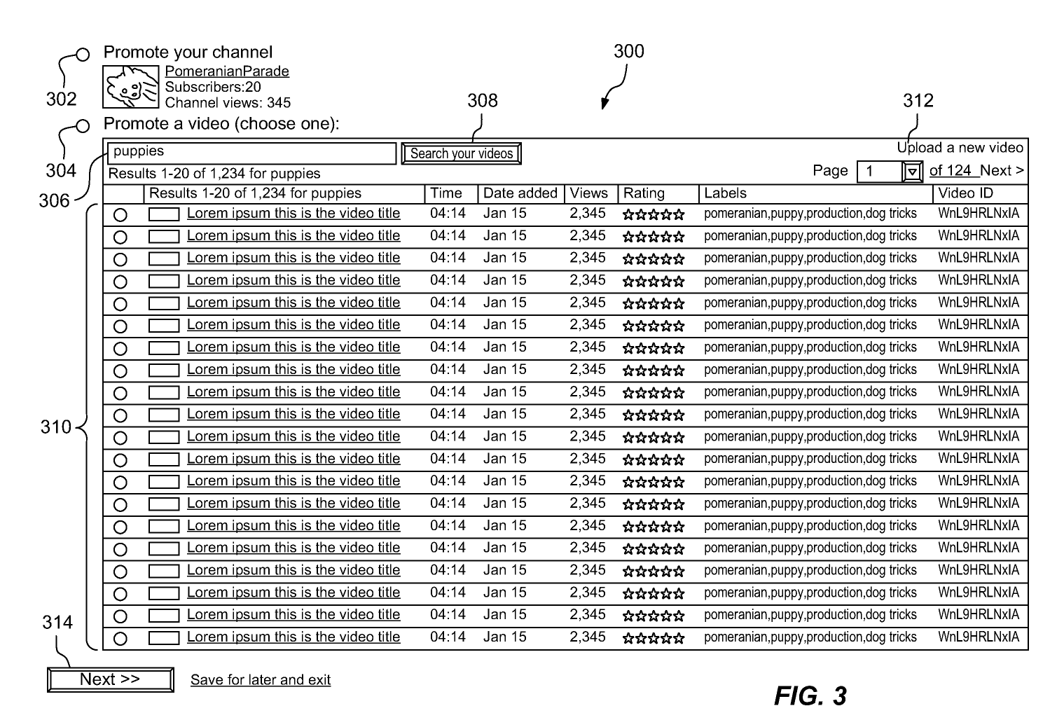

FIG. 3 is an example of a webpage 300 that displays videos available to promoter 132 to designate as promoted videos. In one embodiment, the videos listed are those that have been uploaded by the promoter 132. In alternative embodiments, the videos displayed are those that are owned by the promoter 132. Alternatively, videos may be made available to be promoted in additional ways, such as by designation of video hosting site 106, designation of one user by another who himself has the ability to promote a video, etc. The webpage 300 includes buttons 302 and 304. The promoter selects button 302 if the promoter wishes to promote a channel, or button 304 if the promoter wishes to promote a video. Field 306 allows a promoter to search the list of videos that may be promoted. In this example, the promoter has entered the word “puppies.”

If the promoter 132 finds a video to promote, the promoter clicks on the button next to the title of the video and then clicks on button 314. If the promoter wants to upload a new video to promote, the promoter clicks on link 312 and is directed to a web page allowing video uploads. In one embodiment, the videos available for promotion are a subset of videos available on the site 106. That is, the videos available for promotion may be returned in response to a query either as part of the search results or as connected with a creative served in response to a query. Thus, clicking on a video promotion ad/creative causes control to return to the site 106 and a video from site 106 to be displayed, either on a regular watch page or on a special promotion watch page. Similarly, selection of a creative for a promoted channel causes display of a watch page for the channel from site 106 (or a site controlled by site 106).

FIGS. 4A and 4B are examples of a webpage 400 that allows a promoter 132 to describe details about a video promotion according to one embodiment. Once the promoter 132 selects a video to promote on webpage 300 and clicks on button 314, the promoter is presented with webpage 400. Beginning with FIG. 4A, the webpage 400 includes section 402, which is used by the promoter to design the video promotion creative. Section 402 includes a title field 403 where the promoter can enter descriptive text, such as a title for the video promotion ad. In one embodiment, if the promoter does not enter a title, then the title previously associated with the video is used. The promoter can use fields 404 and 405 to enter a description of the video the video promotion ad will promote. Image 428 is a default video still of the video to be promoted; in an alternative embodiment, promoter 132 can specify either a time stamp from which the video thumbnail should be selected, or can choose from among multiple possible thumbnails offered by ads creation server 116. Activation of button 407 allows the new thumbnail to be chosen.

Section 408 allows promoter 132 to specify what search terms should trigger the video promotion ad to appear in a search results page. Field 410 is where the promoter can enter the search terms that should trigger the video promotion ad to appear. For example, if the promoter enters the word “puppies” in field 410, a match to the promoted video should occur if a viewer searches for videos stored in the video hosting service 106 using the word “puppies”. Field 411 can be used by the promoter to help find related words to include in field 410. In this example, the promoter entered “dog training” in field 411 and after the promoter pressed button 412, the video hosting service 106 determined and presented to the promoter the words 413 or phrases that are related to “dog training.” The identification of related words 413 can be based on automated or manual word-association systems, taxonomies, thesauruses, and the like.

Continuing on to FIG. 4B, webpage 400 includes section 414, which allows promoters to specify which viewers should be targeted by the video promotion ad. In this example, webpage 400 defaults to target English speakers in the United States; a change button allows alternative or additional geographical areas and/or languages to be selected. Section 416 allows the promoter to specify a budget for the video promotion. In field 418, the promoter enters the maximum amount of money the promoter would like to pay per day and in field 420 the promoter enters the maximum amount of money the promoter is willing to pay for the promotion per month. Section 422 allows the promoter to enter in field 424 the amount of money the promoter is willing to pay the video hosting service 106 every time a viewer clicks on the video promotion ad (cost per click). Once the promoter is finished entering information on webpage 700, the promoter submits the various information to the ads creation server 116 via button 426. The ads creation server 116 uses the submitted information to create the video promotion creative. Additional promotion parameters may be included, for example, such as a time-of-day parameter noted earlier, in which the video is promoted or not based on time of day, day of week, etc.; demographics of the requester, including age, gender, location, etc.

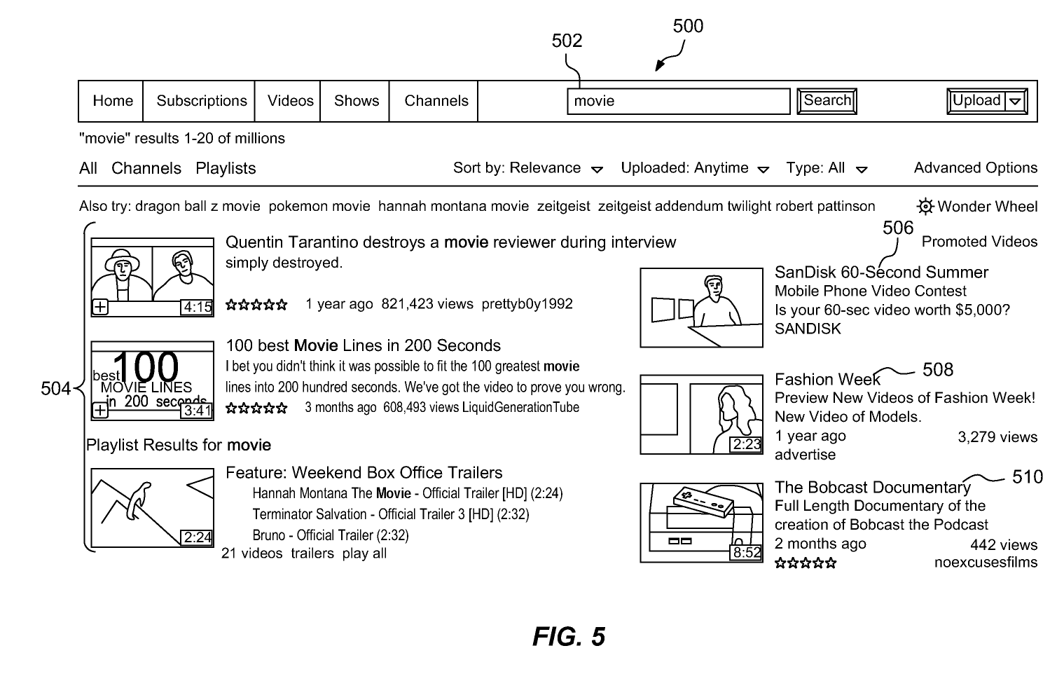

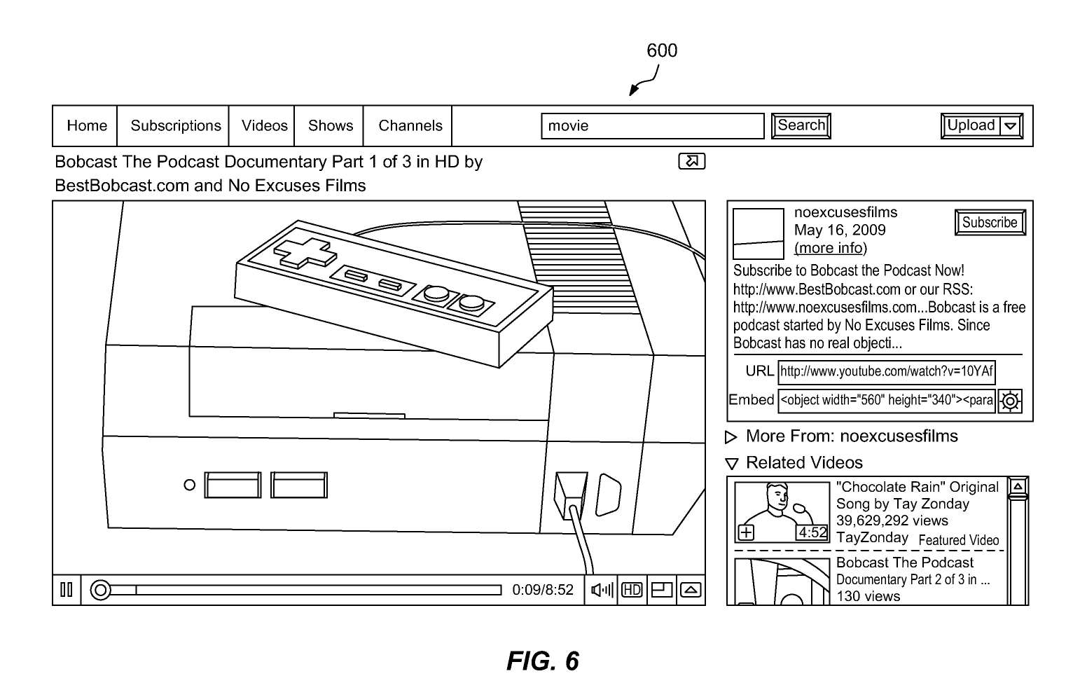

FIG. 5 is an example of a search results webpage 500 including creatives according to one embodiment. The webpage 500 comprises field 502, which includes a search query submitted by a user to the video search server 112. In this example, the user entered a search query of “movie.” Below field 502 are search results 504 of videos identified by the video search server 112 to be relevant to the search query “movie.” To the right of the search results 504, the webpage 500 includes video promotion ads 506, 508, and 510 for promoted videos selected by the ad selection server 120 to be presented to the user based on the specified parameters. Video promotion ad 510 is promoting a video with a title of “The Bobcast Documentary.” It should be understood that in other embodiments the video promotion ad may promote other entities that are not a movie or video. If the user clicks on the video promotion ad 510, the user is directed to a watch page 600 (FIG. 6) on video hosting service 106 that allows the user to watch the promoted video. In one embodiment, the promoted video will automatically play on the watch page. In another embodiment, the user can indicate that the video should play. Thus, clicking on a video promotion ad displays an additional watch page that is served from the video hosting service. This differs from conventional click-through ads because conventional click through ads do not cause a user to be transferred to a page from the same server that serves the video promotion ad. Alternately, conventional click-through ads on a search results page do not cause a user to be transferred to a page from the same server that served the search results. Alternately, conventional click-through ads on a video hosting server do not transfer the user to a watch page on the video hosting server. In one embodiment, the promoted video can be rated by viewers in the same manner as regular videos on site 106, and the view count and rating for a promoted video is automatically inserted into the creative. Note that although in FIG. 5 the creatives for the promoted videos are presented in a manner distinct from the search results, in this case to the right of the organic search results, in alternative embodiments they are presented intermixed with the search results, and may or may not bear a label, highlighting, different font, or other differentiated appearance indicating that they are links to promoted videos.

In one embodiment, the promoter monetizes the display of the promoted video, for example by allowing advertisements for products or services of others to be displayed as overlays on the promoted video, or on the watch page. This may allow the promoter to recoup indirectly some or all of the cost of promoting the video.

In one embodiment, the format of the creative is an image and some text, as described above with respect to FIG. 4A. The creative can be modeled as a variation of an image ad, as a gadget ad of unique dimensions, or its own unique ad type in the backend. The destination URL for this creative is, in one embodiment, a watch page. While a promoter may upload a creative image that has nothing to do with their video, in one embodiment a manual review process is required before uploaded images associated with a promoted video's creative is approved.

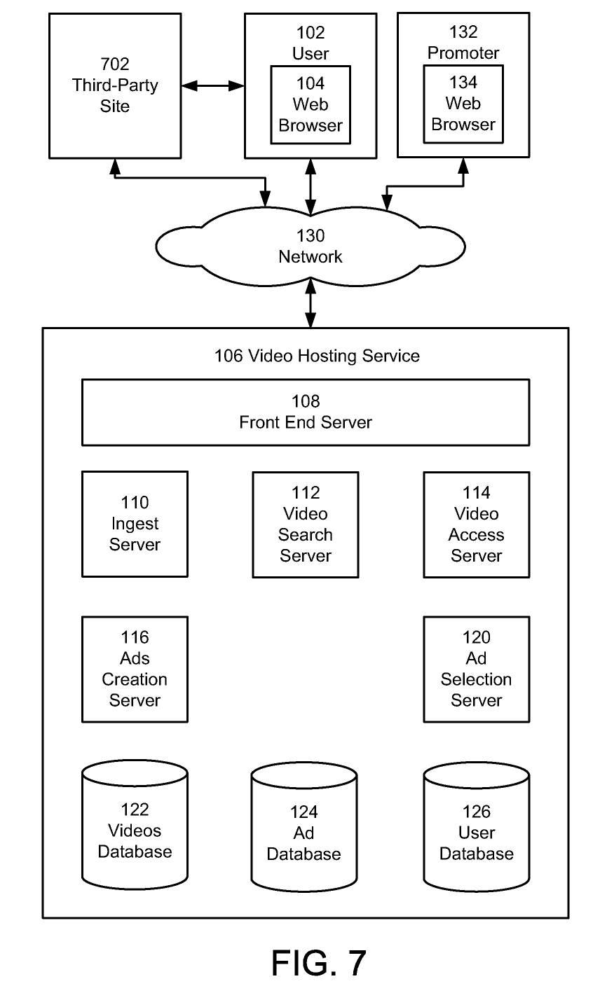

In one embodiment, and referring to FIG. 7, video hosting service 106 promotes the promoter's videos on sites other than hosting service 106. For example, a particular video that promoter 132 wishes to promote may be about cars. A website 702 dedicated to car enthusiasts may subscribe to the video hosting service's advertising service, such that when a user of the car enthusiast site performs a search of the car enthusiast site 702, the search query is forwarded by site 702 to ad selection server 120, and indicia such as a creative of a matching promoted video is returned to the car enthusiast site 702 to be displayed to the user 102 in addition to that site's own organic search results. Various financial arrangements may be used such that video hosting service 106 and the third party web site receive revenue from the cost paid by the promoter 132 for the promotion. The video being promoted is stored by video hosting service 106, and following a click through the indicia by the viewer, the viewer is directed to watch the video on video hosting site 106. In alternative embodiments, the video is stored by the third party site, or even by a different hosting service.

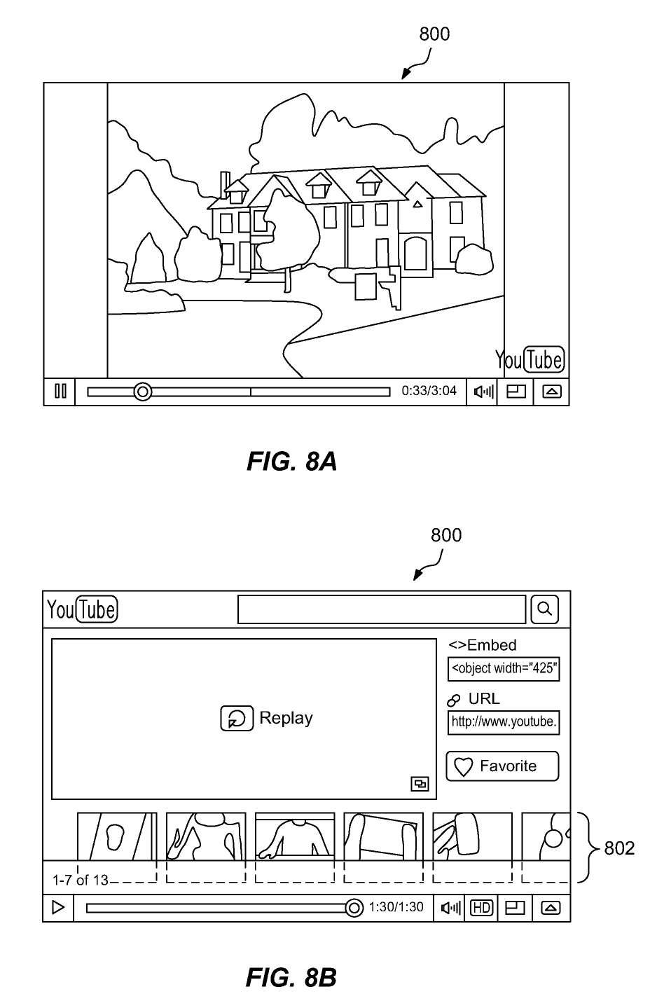

Referring to FIGS. 8A and 8B, in some embodiments, a video player 800 for playing videos stored on video hosting service 106 is embedded on other websites. After an initial video is played, as depicted in FIG. 8A, an indication of related videos and promoted videos 802 available from video hosting service 106 are shown to the viewer, as illustrated in FIG. 8B. The promoted videos may be, but need not be, related to the video just watched. For example, indicia of a promoted video that is not related to the video just watched may be chosen for display based on business criteria such as contractual arrangements between the promoter and video hosting service 106, revenue maximization, etc. Selecting one of the videos causes it to be displayed in the embedded video player. A financial arrangement between the site embedding the promoted video and video hosting site 106 in some embodiments allows a portion of the fee received by video hosting site 106 from the promoter to be shared with the site embedding the promoted video. In some embodiments, related and promoted videos are displayed in the video player following presentation of the video not only in players embedded on third party sites, but also in players displayed on web pages of video hosting service 106. Note also that while illustrated here as being displayed post-roll, i.e. after the initial video has been watched, these related and promoted video selections may in alternative embodiments be displayed pre-roll, or overlaid on a region of the video while it is playing. A determination that two videos are related may be made using methodologies known in the art, such as comparison of keywords and other metadata, user viewing patterns, etc.

In one embodiment, promoter 132 can specify as part of promotion parameters a set of filters in addition to keywords to restrict when the promoted video will be included in search results. For example, if video site 106 supports storage of demographic information in user database 126 for users of the site, then promoter 132 can choose to have his video promoted according to those tracked demographics. A promoter might determine that it is only valuable for him to promote a particular video to a North American audience; or to women; or to men under 30 years old, or to viewers who have already watched one or more of a certain set of other videos available on the site. These additional parameters are stored along with the advertising information for the promoted video in ad database 124, and are considered by ad selection server 120 when selecting a promoted ad to include with search results.

Reference in the specification to “one embodiment” or to “an embodiment” means that a particular feature, structure, or characteristic described in connection with the embodiments is included in at least one embodiment of the invention. The appearances of the phrase “in one embodiment” or “a preferred embodiment” in various places in the specification are not necessarily all referring to the same embodiment.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of a method. It should be noted that the process steps and instructions of the present invention can be embodied in software, firmware or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The methods and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

While the invention has been particularly shown and described with reference to a preferred embodiment and several alternate embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

We claim:

1. A method for promoting video content on a video hosting site, the method comprising:
receiving by a video hosting site a request from a promoter to promote an item of video content according to a plurality of promotion parameters;
receiving from a user a search request at the video hosting site;
displaying a set of search results in response to the search request, the search results including indicia of video content satisfying the search request; and
responsive to a determination that the search request satisfies at least some of the promotion parameters, displaying indicia of the promoted item of video content in addition to the search results.

2. The method of claim 1 further comprising:
receiving the promoted item of video content; and
storing the received promoted item of video content at the video hosting site.

3. The method of claim 1 wherein the item of video content was created by the promoter.

4. The method of claim 1 wherein the item of video content was provided to the video hosting site by the promoter.

5. The method of claim 1 further comprising:
receiving a request from the user for the promoted item of video content.

6. The method of claim 5 further comprising:
providing the promoted item of video content to the user from the video hosting site in response to the request.

7. The method of claim 6 further comprising:
displaying an advertisement associated with an advertiser to the user in addition to providing the promoted item of video content; and
receiving payment from the advertiser in exchange for the display of the advertisement.

8. The method of claim 5 wherein the video hosting site receives a plurality of search requests satisfying at least some of the promotion parameters, the indicia of the promoted item of video content is displayed a plurality of times in response to the plurality of search requests, and further comprising:
receiving, by the video site, a payment proportional to a number of times the promoted item of video content is requested.

9. The method of claim 5 wherein the video hosting site receives a plurality of search requests satisfying at least some of the promotion parameters, the indicia of the promoted item of video content is displayed a plurality of times in response to the plurality of search requests, and further comprising:
receiving a payment proportional to a number of times the indicia of the promoted item is displayed.

10. The method of claim 1 wherein receiving the request to promote the item of video content further comprises:
displaying to a promoter indicia of each of a plurality of video content items for which promotion can be requested; and
receiving a selection by the promoter of at least one of the identified video content items.

11. The method of claim 10 wherein each of the plurality of video content items was created by the promoter.

12. The method of claim 10 wherein each of the plurality of video content items was provided to the video hosting site by the promoter.

13. The method of claim 1 further comprising receiving an indication not originating from the promoter that the item of video content identified by the promoter's request can be promoted.

14. The method of claim 1 wherein the promotion parameters include a set of one or more keywords.

15. The method of claim 1 wherein the promotion parameters include a geographic limitation.

16. The method of claim 1 wherein the promotion parameters include a time limitation.

17. The method of claim 1 wherein the promotion parameters include a limitation based on demographic information of a user making the search request.

18. The method of claim 1 wherein the promotion parameters include a daily budget amount.

19. The method of claim 1 wherein the promotion parameters include a cost-per-click amount.

20. The method of claim 19 wherein the cost-per-click amount is a maximum amount.

21. The method of claim 1 wherein displaying indicia of the promoted item of video content further comprises displaying the indicia in a manner distinct from the search results.

22. The method of claim 21 wherein the distinction includes a difference in placement of the indicia on a web page.

23. The method of claim 21 wherein the distinction includes highlighting the indicia.

24. A method for promoting video content on a video hosting site, the method comprising:
displaying a first video content item to a user of a web site operated by a first entity, the first video content item stored on a video hosting site operated by a second entity;
displaying indicia to the user of a promoted video content item, the promoted video content item stored on the video hosting site and provided to the video hosting site by a promoter;
receiving a request from the user to view the promoted video content item; and
displaying the promoted video content item to the user.

25. The method of claim 24 wherein displaying the promoted video content item to the user further comprises providing a resource identifier to a browser operated by the user, the resource identifier specifying the promoted video content located on the video hosting site.

26. The method of claim 24 wherein the promoted video content item is determined by the video hosting site to be related to the first video content item.

27. The method of claim 24 further comprising receiving a payment from the video hosting site, the payment representing a portion of a payment received by the video hosting site from the promoter in exchange for promotion of the promoted video content item.

28. A method for promoting video content on a video hosting site, the method comprising:
receiving a search request from a user at a first web site, the first web site including a first plurality of content items;
transmitting a request based on the search request to a video hosting service;
receiving from the video hosting service, in response to the transmitted request, indicia of a video content item, the video content item stored by the video hosting service, the video content item having promotion parameters received from a promoter corresponding to the transmitted request;
displaying a set of search results in response to the search request, the search results including indicia of content items of the first plurality of content items that satisfy the search request; and
displaying the indicia of the video content item received from the video hosting service.

29. The method of claim 28 further comprising:
receiving a selection by the user of the indicia of the video content item received from the video hosting service; and
displaying the selected video content item to the user.

30. The method of claim 29 wherein displaying the selected video content item to the user further comprises providing a resource identifier to a browser operated by the user, the resource identifier specifying the selected video content located on the video hosting site.

31. A method for promoting video content on a video hosting site, the method comprising:
transmitting a video content item to a video hosting site; and
providing promotion parameters associated with the video content item to the video hosting site, the parameters including at least one keyword and an advertising creative to be displayed with indicia of the video content item in response to a search request received from a user of the video hosting site and including the keyword.

32. The method of claim 31 further comprising:
making payment to the video hosting site according to a number of times the video content item is viewed by a user of the video hosting site responsive to the displayed indicia.

33. A method for promoting video content on a video hosting site, the method comprising:
receiving by a video hosting site a request from a plurality of promoters to promote items of video content, each request including promotion parameters;
receiving a search request at the video hosting site;
selecting based on the search request and the received promotion parameters at least one video to promote;
displaying a set of search results in response to the search request, the search results including indicia of video content satisfying the search request; and
displaying indicia of the selected video in addition to the search results.

34. The method of claim 33 wherein the promoted items of video content are stored by the video hosting site, the method further comprising:
receiving a request from a user to view one of the selected videos; and
displaying the requested video to the user.

35. A system for promoting video content on a video hosting site, comprising:
an advertisement creation server adapted to receive requests from promoters to promote items of video content, each request including promotion parameters;
a videos database, coupled to the advertisement creation server, adapted to store video content on storage media;
a video search server, coupled to the videos database, adapted to receive and execute search requests to identify videos in the videos database having associated data corresponding to the search requests and to display indicia of the identified videos as search results; and
an advertisement selection server coupled to the videos search server, adapted to select an item of video content for promotion based on a match between the search request and promotion parameters and to provide indicia of the selected item to the video search server to display in addition to the identified search results.

36. A computer program product for promoting video content on a video hosting site, the computer program product stored on a computer readable medium and including executable code that, when executed, causes a computer to carry out the steps of:
receiving by a video hosting site a request from a plurality of promoters to promote items of video content, each request including promotion parameters;
receiving a search request at the video hosting site;
selecting based on the search request and the received promotion parameters at least one video to promote;
displaying a set of search results in response to the search request, the search results including indicia of video content satisfying the search request; and
displaying indicia of the selected video in addition to the search results.

37. The computer program product of claim 36 wherein the promoted items of video content are stored by the video hosting site, and the code is further configured to cause the computer to perform the steps of:
receiving a request from a user to view one of the selected videos; and
displaying the requested video to the user.
